(19) United States
(12) Patent Application Publication
(10) Pub. No.: US 2004/0176929 A1
(43) Pub. Date: Sep. 9, 2004

(54) Monitoring and maintaining equipment and machinery

(76) Inventors: Dirk Joubert, Alpharetta, GA (US); Klaus Kruppel, Rimpar, DE (US)

Correspondence Address: TECHNOPROP COLTON, L.L.C., P O BOX 567685, ATLANTA, GA, 311567685

(21) Appl. No.: 10/794,289

(22) Filed: Mar. 5, 2004

Related U.S. Application Data
(63) Continuation of application No. 60/452,992, filed on Mar. 7, 2003.

(51) Int. Cl. G01N 21/00

(52) U.S. Cl. 702/184

(57) ABSTRACT

A method and system for the maintenance and monitoring of equipment and machinery by monitoring equipment and machinery conditions, maximizing equipment and monitor utilization or disposition, and thereby maximizing the net effective value.

### STATEMENT OF RELATED APPLICATIONS

This application is the Nonprovisional patent application based on and claiming priority on U.S. Provisional patent application No. 60/452,992 having a filing date of 7 Mar. 2003.

### BACKGROUND OF THE INVENTION

1. Technical Field

The present invention generally relates to a process, including a method and system, for the monitoring and maintaining equipment and machinery, as well as any other device or system that has discrete measuring points that can be gathered and analyzed to determine the status of the device or system. More particularly, the present invention relates to a method and system for monitoring equipment and machinery conditions and utilization or disposition, and thereby maximizing the net effective value of the equipment and machinery. The present invention also generally relates to a business method for applying the process of the present invention.

2. Prior Art

Monitoring and maintaining systems, equipment and machinery is necessary to extract the highest value from the system, equipment or machine. A poorly monitored or maintained system, equipment or machine often does not perform at its peak, and can lead to higher costs due to lower efficiency and failure. Currently, there are a number of methods for monitoring and maintaining systems, equipment and machinery; however, those methods known to the inventor are for the most part either retroactive to a past history of maintenance, responsive to a current failure or condition, or based on suggestions made by the manufacturer or builder.

As an example of a current process, lubricant analysis has become the norm for most operators of equipment, in particular diesel engine machinery. Specifically, expensive heavy construction equipment uses both fuels and fluids, including lubricants, and must be monitored and maintained to remain in peak condition. In most cases diagnostics from spectrochemical and other forms of analyses do not provide the user the means to make properly informed decisions regarding maintenance. For example, fluids can be analyzed for impurities and other conditions. However, such basic analyses do not give the user the ability to determine whether the equipment needs maintenance. Moreover, the skills and time required to disseminate and understand the analysis is not only lacking, but also mostly done subjectively without any coordination with maintenance personnel, resulting in most cases in more downtime and higher maintenance costs, instead of lower costs and higher optimization of assets.

As a result most operators, to be safe, follow historical standards or suggested maintenance schedules, which may or may not actually provide an optimal economical result. The advent of full maintenance lease programs offered by major original equipment manufacturers (OEMs) may ultimately alleviate some of the operator's predicaments. In addition, as many of the fluids used in such machinery are petroleum-based, competitive pressure between petroleum marketers is forcing them to re-evaluate their service offerings to include value added non-core technology, such as maintenance programs, not only to retain clients, but also to generate incremental non-core revenue.

Another known maintenance process is reliability centered maintenance (RCM), which is a human process aimed at continuously improving the human-machine relationship. RCM is a prerequisite for condition based maintenance (CBM) and the optimization thereof by tools such as EXAKT®). The convention al approach to CBM has borne only mediocre result. CBM was initially based on the premise that collecting large amounts of data would lead to the development of useful predictive models, using, for example, trend or regression analysis and statistical process control methods. For the most part, this did not succeed for two reasons. First is the influence of age on the risk of failure, meaning that the correct interpretation of measured condition indicators will vary according to the working age of the unit. Second is the influence of external non-random events on the values of the measured indicators, meaning that something as simple as changing the oil must be taken into account in the overall analysis.

The use of artificial/expert intelligence in business operations and processes is growing exponentially, which in turn is driving outsourcing of vertical/expert skills. Applying such artificial/expert intelligence to the monitoring and maintenance fields currently is a fledgling industry, yet it has the potential to revolutionize the fields.

It can be seen that there is a need for a solution that allow users to monitor and maintain systems, equipment and machinery that will offer more optimal prognostics with activity suggestions, and a means to ensure more accurate data input and a collaborative tool to coordinate it all.

### BRIEF SUMMARY OF THE INVENTION

The present invention is a process, including a system and method for monitoring and maintaining systems, equipment and machining, and a business method for implementing the process. Briefly, the invention includes the monitoring of the components of a system, piece of equipment or machine, obtaining values pertaining to the status of the components, recording these values, and analyzing the values to determine the optimum schedule for maintaining the system, piece of equipment or machine. By obtaining the values pertaining to the status of the components, the process can determine for the user whether any activities need to be undertaken with regard to the system, piece of equipment or machine. Further, by building up a history of values, the process can determine whether the suggested or historical maintenance or other schedule is suitable, or whether a new schedule is more appropriate to save on maintenance costs or to prevent premature failure of the system, piece of equipment or machine.

In one embodiment, the invention includes identifying, sourcing and interfacing multiple components to provide a solution that includes the day to day operational directives pertaining to short term savings and establishes the platform from which informed and intelligent longer term maintenance decisions can be made and longer term monitoring can be achieved. For example, in the diesel equipment industry, the invention can help determine whether it is time to change the oil or oil filter on a piece of construction equipment, or to allow the equipment to continue to operate. Premature oil changes, even if scheduled, cost money. Thus, the system and method of the invention can provide short-term tangible value to the user.

These features, and other features and advantages of the present invention, will become more apparent to those of ordinary skill in the relevant art when the following detailed description of the preferred embodiments is read in conjunction with the attached appendices and the appended drawing.

### BRIEF DESCRIPTION OF THE FIGURES

FIG. 1 is a flow chart of the process of the invention.

### BRIEF DESCRIPTION OF THE APPENDICES

Appendix A contains examples of the algorithms for the process of the present invention, as well as example results.

Appendix B is a paper describing an automated system for the determination of acid and base number by differential FTIR spectroscopy, which can be used as a component of the present invention.

### DETAILED DESCRIPTION OF THE PREFERRED EMBODIMENT

The present invention relates to a process, including a method and system for monitoring and maintaining systems, equipment and machinery, and a business method for implementing the process. Although the invention can be used in connection with any system, piece of equipment or machine from which discrete values regarding the status of the system, piece of equipment or machine can be obtained, the following specification will use as the illustrative embodiment a method and system that allows a user to monitor and maintain heavy industrial or construction equipment and machinery by analyzing sensors and lubricant samples from the unit. However, it should be kept in mind that the following discussion can be analogized to other industries, such as but not limited to aircraft monitoring and maintenance, building and bridge monitoring and maintenance, chemical and manufacturing plant equipment monitoring and maintenance, medical imaging device monitoring and maintenance, and the like.

In general, the invention can provide the user with cost benefit analyses of the nature of the repair or maintenance for a unit. For example, the invention can provide the user with a guide as to whether it is more cost efficient to repair a monitored unit or whether it is more cost efficient to simply replace the unit at a certain time or upon failure. For another example, the invention can provide the user information on whether the unit has been maintained too frequently. Thus, from the cost benefit analysis, a user can determine the best course of future maintenance and repair for a piece of machinery or equipment. For ease of discussion, systems, pieces of equipment and machines will be referred to using the term unit or units.

The invention can be informally described as a process for collecting maintenance relevant information and objectively, systematically and consistently using this information to monitor and maintain units. By doing so, the creation of a historical database will allow the creation of a better predictive maintenance schedule for the unit. This in turn will allow more predictable RCM.

1. Process.

The method and system can be in many different forms, a basic version of which comprises the steps of:

(1) Obtaining the output data of the values from the machinery and equipment to monitored and maintained;

(2) Entering the values or updating the appropriate fields for downstream predictive decision or modeling of the machinery and equipment;

(3) Applying to the output data a series of database algorithms, probability matrices, and solutions to determine an immediate situational response and activity directives for dealing with the machinery and equipment;

(4) Retrieving real time, or near real time, updates of actions taken responses, or activity directives, regarding the machinery and equipment;

(5) Retrieving field situational comments regarding the machinery and equipment;

(6) Receiving comments on field activities regarding the machinery and equipment as found; and

(7) Allowing updates to the database as pertinent to the maintenance and monitoring of the current data output.

An additional feature of the invention allows the retrieval of all information for data mining and cost benefit modeling.

Following is a more detailed disclosure of the steps of the present invention. Appendix A contains more detailed information and examples relating to these steps, and should be referred to with the following disclosure.

The first step can include receiving output from the unit. In one embodiment, various sensors can be installed on the unit to collect data for analysis. Such sensors can be mounted virtually anywhere on or in the unit. Such sensors may each be hard wired in place with individual connections, and data thereform can be received as an analog or digital data signal and converted into useable data for the system or method according to the present invention.

Data that can be collected and received from the unit can be various. In the current example, such data can include lubricant data such as viscosity, mineral composition (e.g. iron, copper, lead, fuel soot, oxide, nitride, and sulfur composition), and water concentration. Additionally, such data can also include physical data such as pressure or temperature. Further, more such data can include more complicated parameters such the total acid number and the total base number of various fluids used by the unit. Other data that can be collected and received from the machinery is obvious to those of ordinary skill in the art.

In an aircraft monitoring and maintenance example, the data can include engine run time, lubricant composition and viscosity, hydraulic fluid composition and viscosity, and temperatures and pressures for the various components of the aircraft. Similarly, this data can be analogized in the marine craft field. In a building and bridge monitoring example, the data can include sway rates and distances, cable tension and elongation, position shifting, elevator usage, and heating, ventilation and air conditioning (HVAC) parameters. These few examples are given to show that the present invention is not to be restrained to the lubricant field.

The second step, after the output information has been received, can include entering or updating the appropriate fields for downstream predictive decision modeling pertinent to the unit or component being monitored or managed. At this point, parameters such as the fluid type or brand, fluid service time, equipment specifications (e.g. equipment type, manufacture, model), and current and history data (e.g. past viscosity, wear metals, contamination, or additive depletion) can be inputted. In one embodiment, there are default parameters so that every parameter does not have to be inputted from the beginning.

The third step can include the application of a series of database algorithms, probability matrices, and database solutions to the data collected to determine the immediate situation responses directives. At this step, the invention can provide an estimate of residual life for the lubricant or for the equipment. In one embodiment, the system can learn from previous applications. Appendix A describes one method for formulating the necessary database of algorithms, probability matrices, or solutions. As an example, in this step, the invention can alert the user that the lubricant is close to its highest level of contamination, and must be changed, or that the lubricant still has an effective life of a certain time period. Likewise, the invention can alert the user that the lubricant contains impurities related to the possible failure of another component of the unit.

The fourth step can include inputting and receiving real, or near real time, updates of actions taken. For example, corrective measures or recent activity performed on the unit can be inputted. Such inputs can be either per work order, or per period, or any other time period. Information received based on these inputs can include generation of mean time before failure (MTBF) reports and the like.

The fifth step can include receiving comments from the invention on the field activities and recorded by the invention. For example, if a corrective action is required on a unit, the invention can notify that such a corrective action is needed. The invention at this point can also generate scheduled maintenance work orders.

The sixth step can include receiving comments on field activities.

The seventh step can allow updates to the database as pertinent to the maintenance point in question, materials requirement planning (MRP). The database is updated based on probable failure, or preventive maintenance directives, for the unit. Thus, based on the pattern of previous maintenance of the unit, the database will contain additional information as the method is used.

The eighth additional step can include allowing a user to retrieve past information and to examine trends in the maintenance and monitoring of the unit. For example, the data collected for prognostic oil change decisions can be mined to develop condition based models to determine the economically most viable maintenance option as it pertains to assemblies, i.e., a determination of preventative versus replacement based on current maintenance. Further, fluid test data input into a lube condition prognosticator model (LCPM) can allow the user to assess parameters such as the fluid condition and later the machinery condition.

The process uses a number of available agents as components of the whole. One agent is a statistical modeling technique for the prediction of failure and the estimation of residual component life. A commercial example of this agent is EXAKT®, which is incorporated herein by this reference. A second agent is an adaptive expert system shell that has the potential of widening the electronic communication link between the user and the customer. A commercial example of this agent is SOLVATIO®, which is incorporated herein by this reference. A third agent is some type of analyzer to analyze one or more components. A commercial example of this agent is any device utilizing Fourier Transform Infrared spectroscopy (FTIR) for fluid analysis, for example, such as the COATS system described in Appendix B.

For specific embodiments of the invention, such as the lubricant embodiment, a lubricant condition prognosticator model (LCPM) can be used. An LCPM allows the invention to assess fluid conditions and machinery conditions. The lubricant manufacturer's fluid specifications can then be matched to known possible conditions and compared with diagnoses, results, conclusions, solutions and failure modes of the units over time. This will allow the invention to create and attach a reliability factor, and estimate residual life for both the lubricant and the unit. The adaptive expert system shell discussed previously has such a capability, as well as the capability to learn and adapt such estimates and factors over time.

Somewhat more specifically, input data can include parameters such as the fluid brand and type, the suggested fluid service time, the operating context (equipment type, manufacturer and model, operating conditions, and equipment age), and fluid test data (current and historical, viscosity, wear metals, contaminations and additive depletion such as water, silicon and degradation products). Once this data is inputted, current fluid data and parameters then can be compared to this base data and a determination made as to whether the fluid needs to be replaced or not. Further, the amount and type of contaminants in the fluid can give an indication of whether a different component is malfunctioning or getting ready to fail.

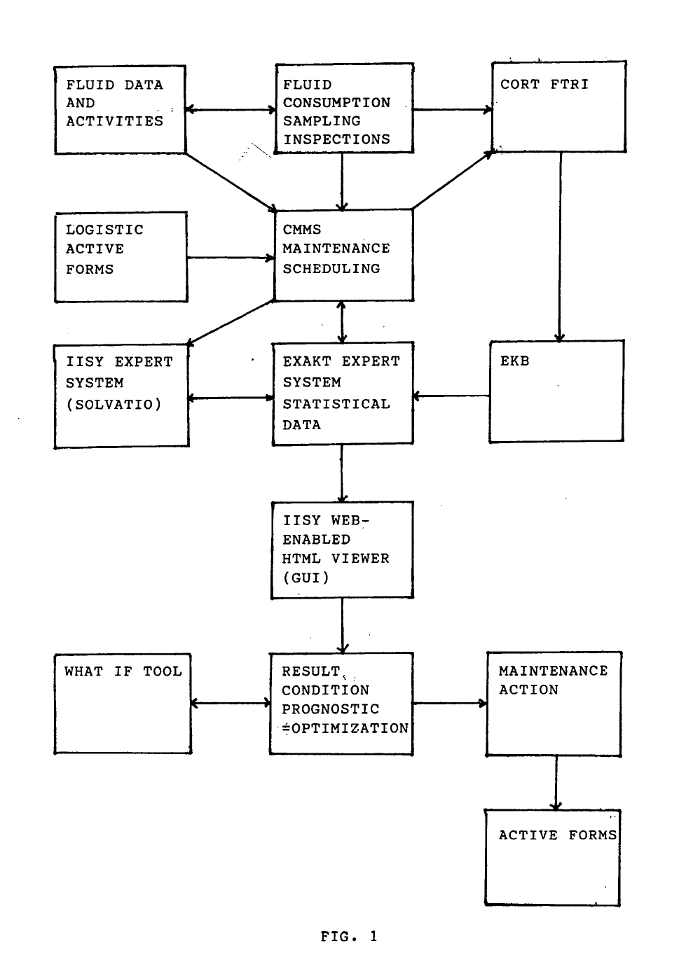

Referring now to FIG. 1, a generalized flow chart of the process of the invention is shown. The first level of the flow chart is the equipment level step. In the fluid or lubricant example, the fluid data and activities are monitored and recorded. This fluid management steps comprises the electronic recording of fluids used by the unit and field actioned work orders. Further, fluid consumption sampling inspections are taken. More specifically, this involves taking actual samples of the fluids and inspecting. The samples can be sent for analysis, such as in a CORT FTIR system. The results of the analysis are sent to the EKB module in the third level.

The information gleaned from the first level is sent or inputted into the CMMS computer maintenance management system for maintenance scheduling. An example commercial application for CMMS is the J4 SMEM® scheduled maintenance planning software. The CMMS module receives input from the fluid data and activities module, the fluid consumption sampling inspections module and the logistic active forms, as well as from the expert system statistical data module on the third level. The CMMS module then constructs a maintenance schedule for the unit.

Information regarding the maintenance schedule data from the CMMS module is sent or inputted to the third level to a statistical modeling technique module for the prediction of failure and the estimation of residual component life, such as the EXAKT® agent disclosed above, and to an adaptive expert system shell that has the potential of widening the electronic communication link between the user and the customer, such as the SOLVATIO® agent disclosed above. The statistical modeling technique module also receives the fluid analysis data from the EKB module.

The statistical modeling technique module and the adaptive expert system shell analyze various aspects of the data from the CMMS module, such as maintenance and lifetime information, and determine a conclusion as to when maintenance should be conducted on the unit. For example, by combining suggested maintenance activities (that is, the maintenance schedule suggested by the manufacturer) and historical data (that is, when and what maintenance has been performed on the unit) as well as the results of the fluid analyses (which can tell whether the fluid is at or near a state that needs replacement, or whether various components of the unit may be wearing), the system develops a maintenance schedule for the unit. This maintenance schedule may be the same as or different from the maintenance schedule suggested by the manufacturer, or the historical maintenance schedule, and is based on the actual factors pertaining to the particular unit, and not to a generalized group of like units.

The analysis and scheduling developed on levels 3 and 2 can increase productivity, as the maintenance schedule will be more exact and more relevant to the individual unit. The system can predict both maintenance that needs to be performed and potential problems that may arise based on a historical and real time snapshot of the particular unit.

A web-enabled HTML viewer (a GUI—graphical user interface) allows the user to interact with the system. Through the GUI, the user can review any number of data, such as the data inputted into the system, the scheduled maintenance, the historical maintenance, and/or the maintenance schedule developed by the system. Further, the system provides a result condition prognostic for the unit, which helps the user optimize the operation and maintenance of the unit. Through this result condition prognostic, the user can decide what, if any, maintenance actions to take and to prepare the appropriate active forms.

Further, a what if module can be used to set up various different scenarios. The user can use the what if module to obtain an indication of whether the unit may need earlier or later maintenance, or fail, based on certain operating and/or maintenance assumptions. For example, if the system indicates that a certain maintenance activity should be carried out after 20 hours of operation of the unit, the user can use the what if module to obtain an indication of whether running the unit for 22 hours would increase the need for maintenance, would increase the chance of failure, and the like.

The entire process is software driven, and thus is efficient and rapid. Additionally, the entire process can be contained in a hardware solution that is attached directly to the unit. This would allow remote collection and analysis of data and the ability to store the data about a particular unit on the unit itself. Further, the statistical modeling technique module for the prediction of failure and the estimation of residual component life, and the adaptive expert system shell are self-learning, and provide the system with the ability to revise the maintenance scheduling in real time for the particular unit. As such, the maintenance scheduling is not set for a unit, but can change as the unit changes over its lifetime.

As can be seen, the system drills down to review the data from a particular unit, and not just the type of unit. For example, the system reviews the particular backhoe and develops a maintenance schedule for that particular backhoe, rather than averaging data for all backhoes contained in the system. This allows greater efficiency and optimization for the operation and maintenance for each individual unit.

2. Business Method.

The invention also comprises a business method of implementing the process. Such a business method can allow a separate company or a user to monitor and maintain the units. For a separate company, this would allow for an income stream for providing the service. For the user, this would allow savings due to more efficient and economical monitoring and maintenance.

A general outline of the business method is:

a. Revenue Streams:

i. License fees—One time charge (user),

ii. Use license fees—Monthly charge to Petroleum Marketers and OEM's for corporate/product self-analysis. This typically includes proof of concept/quality.

iii. Management fees—Monthly/Quarterly charge (includes server maintenance costs),

iv. Change, no change directives for oil and filters—Per sample/view,

v. Probable cause reports—Per sample/view,

vi. Generation of scheduled maintenance work orders—Either per work order, or per period,

vii. Generation of Mean Time Before Failure (MTBF) reports—Per view,

viii. Economically Optimal Maintenance Actions reports (EOMA)—Per view,

ix. MRP (Materials Requirement Planning)—Based on probable failure, or preventive maintenance directives—Per report.

x. RCM training, and consulting.

b. The Market And Size (Global):

At present oil analysis laboratories are processing approximately 60-75 million samples per year. Assuming that a “maintenance point” is analyzed on average 6 times per year, this would indicate a business opportunity that consists of >10 million maintenance points/assemblies.

c. Accessing the Market:

In order to rapidly access the market it is intended to leverage the high-profile credible resources of the petroleum marketers and OEM's to generate the profile required for acceptance of the technology/process/science. A win-win recipe, as detailed in the BP Joint Initiative document, has been identified as the most likely to succeed.

d. Industries:

Illustrative industries in which this process can be utilized include petroleum Marketers, Construction, and Mining entities, and OEM's of Construction equipment.

The above detailed description of the preferred embodiments and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. A system for monitoring and maintaining a unit comprising the steps of:
a. obtaining parameter data from the unit;
b. analyzing the parameter data using a statistical modeling technique module and an adaptive expert system shell for the prediction of an event in the lifetime of the unit; and
c. using the analyzed data to developed a maintenance schedule for the unit.

2. A system for monitoring and maintaining a unit comprising the steps of:
a. obtaining parameter data from the unit pertaining to the status of at least one component of the unit;
b. analyzing the parameter data using a statistical modeling technique module to develop a maintenance schedule for the unit;
c. analyzing the parameter data using an adaptive expert system shell for the prediction of an event in the lifetime of the unit; and
d. providing the analyzed data to a user to implement a maintenance and monitoring schedule for the unit.

3. A system for monitoring and maintaining a unit comprising the steps of:
a. obtaining parameter data from the unit;
b. analyzing the parameter data using a statistical modeling technique module and an adaptive expert system shell for the prediction of an event in the lifetime of the unit;
c. using the analyzed data to developed a maintenance schedule for the unit; and
d. providing the analyzed data to a user to implement a maintenance and monitoring schedule for the unit.

4. A system for monitoring and maintaining a unit comprising the steps of:
a. obtaining parameter data from the unit;
b. analyzing the parameter data using a statistical modeling technique module and an adaptive expert system shell for the prediction of an event in the lifetime of the unit;
c. using the analyzed data to develop a maintenance schedule for the unit;
d. providing the analyzed data to a user to implement a maintenance and monitoring schedule for the unit; and
e. allowing the user to alter the parameter data to create an alternate hypothetical maintenance and monitoring schedule.

5. A system for monitoring and maintaining a unit comprising:
a. a first means located on the unit for gathering and transmitting parameter data about the unit;
b. a second means located remote from the unit for receiving the parameter data about the unit from the first means; and
c. a third means for analyzing the parameter data using a statistical modeling technique module and an adaptive expert system shell for the prediction of an event in the lifetime of the unit,
wherein the analyzed data is used to developed a maintenance schedule for the unit and to allow a user to implement a maintenance and monitoring schedule for the unit.

6. A system for monitoring and maintaining a unit comprising:
a. a first means located on the unit for gathering and transmitting parameter data about the unit; and
b. a second means located remote from the unit for receiving the parameter data about the unit from the first means, and for analyzing the parameter data using a statistical modeling technique module and an adaptive expert system shell for the prediction of an event in the lifetime of the unit,
wherein the analyzed data is used to develop a maintenance schedule for the unit and to allow a user to implement a maintenance and monitoring schedule for the unit.
